(19) United States
(12) Patent Application Publication
(10) Pub. No.: US 2019/0058328 A1
(43) Pub. Date: Feb. 21, 2019

(54) METHODS AND SYSTEMS FOR MANAGING SALE AND PURCHASE OF SOLAR CREDITS

(71) Applicant: Latifullah Khan, Brooklyn, NY (US)

(72) Inventor: Latifullah Khan, Brooklyn, NY (US)

(21) Appl. No.: 16/102,788

(22) Filed: Aug. 14, 2018

Related U.S. Application Data
(60) Provisional application No. 62/546,017, filed on Aug. 16, 2017.

(51) Int. Cl. H02J 3/00; G06Q 40/04; G06Q 50/06; H02S 99/00

(52) U.S. Cl. CPC H02J 3/008; H02S 99/00; G06Q 50/06; G06Q 40/04

(57) ABSTRACT

A system for managing a sale and purchase of solar credits as a commodity includes a user interface for enabling users to interact with the system. The system includes a storage module for storing information about the users and solar credits. The system also includes a buying module for enabling the users to buy one or more solar credits. A solar credit comprises a trade certificate issued in form of at least one of points, megawatt of solar energy used, and solar panels installed. The system further includes a selling module for enabling the users to sell the one or more solar credits. The system also includes a trading information output module for generating at least one of a soft copy and a physical copy of a solar credit trading information for each of the users according to one or more compliance and usage regulations set up by a governing system.

### TECHNICAL FIELD

The presently disclosed embodiments relate to the field of renewable energy and its use and application. More specifically, embodiments of the present disclosure relate to methods and systems for managing sale and purchase of a plurality of renewable energy credits or solar credits as a commodity.

### BACKGROUND

The energy sources are primarily characterized as non-renewable energy sources and renewable energy sources. Fossil fuels are the most commonly used non-renewable resources for generating energy. Examples of the fossil fuels may include coal, oil, and natural gas. The non-renewable energy sources are being used faster than they can be replaced; therefore the supply of the non-renewable energy sources available to the world or society is limited. Fossil fuels are formed from fossils that are partially decomposed remains of once living plants and animals. The fossils usually took millions and billions of years to form. Further, when fossil fuels are burned for energy, they release pollutants into the atmosphere. The fossil fuels may also release carbon dioxide, carbon monoxide, and other greenhouse gases that are causing global temperatures to rise. Moreover, the fossils are limited and exhausting at a very high speed. Once the non-renewable energy sources are exhausted, they are, for all practical purposes, gone.

On the other hand, the renewable energy sources are virtually limitless, such as the sun that will continue to shine for years, or can be replaced faster than we can use them. Examples of the renewable energy sources include, but are not limited to, wind, geothermal, biomass, water, and the sun. The amount of falling water and wind may change over the period of time but they are still available in abundance. Further, the biomass energy, such as wood for fire, can also be replaced relatively quickly as compared to the fossils. The renewable energy sources are so abundant or can be replaced so rapidly that, for all practical purposes, they can't run out. Further, as the technology for using the renewable energy sources improves, and more people start to use renewable energy, the prices for harnessing the renewable energy may come down. At the same time, as we use up fossil fuels such as coal, oil, and natural gas, these non-renewable resources will become more expensive. Further, at some point, even if the renewable energy costs are high, the non-renewable energy will be even more expensive compared to the renewable energy.

All energy sources have some impact on our environment though the intensity may vary. The non-renewable energy sources do substantially more harm to the environment than the renewable energy sources by most measures, including air and water pollution, land use, wildlife and habitat loss, damage to public health, water use, and global warming emissions. The exact type and intensity of environmental impacts may vary depending on the specific technology or energy source used, the geographic location, and a number of other factors like population. The world needs to consider environment issues very seriously.

### SUMMARY

In light of above discussion, there exists need for quick, swift, and cost effective solution for resolving the existing environmental issues. As discussed, there arises a need for techniques for managing a sale and purchase of renewable energy/solar energy as a commodity in form of a plurality of renewable energy/solar credits.

The present disclosure provides methods and systems for managing sale and purchase of a plurality of renewable energy/solar credits as a commodity. Each of the plurality of renewable energy/solar credits may include a trade certificate issued to at least one user in form of at least one of a plurality of points, megawatt of renewable energy/solar energy used, and a plurality of renewable energy/solar panels installed.

An embodiment of the present disclosure provides an online trading system for managing a sale and purchase of a number of solar credits as a commodity. The online trading system includes a user interface configured to enable a number of users to interact with the system. The online trading system also includes a storage module configured to store information about the plurality of users and the plurality of solar credits. The online trading system also includes buying module configured to enable the plurality of users to buy one or more of the plurality solar credits, wherein each of the plurality of solar credits comprises a trade certificate issued to at least one user in form of at least one of a plurality of points, megawatt of solar energy used, and a plurality of solar panels installed. The online trading system further includes a selling module configured to enable the plurality of users to sell the one or more of the plurality of solar credits. The online trading system also includes a trading information output module configured to generate at least one of a soft copy and a physical copy of a solar credit trading information for each of the plurality of users according to one or more compliance and usage regulations set up by a governing system.

Another embodiment of the present disclosure provides a method for managing a sale and purchase of a plurality of solar credits as a commodity. The method includes a plurality of users to interact with the system via a user interface. The method includes maintaining, by a storage module, information about the plurality of users, a plurality of computing devices associated with the users, a plurality of suppliers of the solar credits, and the plurality of solar credits, the information comprising one or more credentials of the plurality of users, and past history of solar credits for each of the plurality of users. The method further includes enabling, by a buying module, the plurality of users to buy one or more of the plurality solar credits, wherein each of the plurality of solar credits comprises a trade certificate issued to at least one user in form of at least one of a plurality of points, megawatt of solar energy used, and a plurality of solar panels installed. The method also includes enabling, by a selling module, the plurality of users to sell the one or more of the plurality of solar credits. The method further includes generating, by a trading information output module, at least one of a soft copy and a physical copy of a solar credit trading information for each of the plurality of users according to one or more compliance and usage regulations set up by a governing system.

Another embodiment of the present disclosure provides a system for transacting one or more renewable energy credits online. The system includes an online trading system including a storage module configured to store information about a plurality of users, a plurality of computing devices associated with the users, a plurality of suppliers of the renewable energy credits, and a plurality of renewable energy credits. Each of the renewable energy credits includes a trade certificate issued to at least one user in form of at least one of a plurality of points, megawatt of renewable energy used, and a plurality of panels installed. The online trading system further includes a buying module configured to enable the plurality of users to buy one or more of the plurality renewable energy credits. The online trading system further includes a selling module configured to enable the plurality of users to sell the one or more of the renewable energy credits. The online trading system further includes a trading information output module configured to generate at least one of a soft copy and a physical copy of a renewable energy credit trading information for each of the plurality of users. The system also includes a computing device including a user interface configured to enable the plurality of users to interact with the online trading system.

Yet another embodiment of the present disclosure provides a system for transacting one or more solar credits online. The system includes an online trading system including a storage module configured to store information about a plurality of users, a plurality of computing devices associated with the users, a plurality of suppliers of the solar credits, and a plurality of solar credits. Each of the solar credits includes a trade certificate issued to at least one user in form of at least one of a plurality of points, megawatt of renewable energy used, and a plurality of panels installed. The online trading system further includes a buying module configured to enable the plurality of users to buy one or more of the plurality solar credits. The online trading system further includes a selling module configured to enable the plurality of users to sell the one or more of the solar credits. The online trading system further includes a trading information output module configured to generate at least one of a soft copy and a physical copy of a solar credit trading information for each of the plurality of users. The system also includes a computing device including a user interface configured to enable the plurality of users to interact with the online trading system.

Another embodiment of the present disclosure provides a method for managing a sale and purchase of a plurality of renewable energy credits as a commodity. The method includes a plurality of users to interact with the system via a user interface. The method includes maintaining, by a storage module, information about the plurality of users, a plurality of computing devices associated with the users, a plurality of suppliers of the renewable energy credits, and the plurality of renewable energy credits, the information ay include one or more credentials of the plurality of users, and past history of renewable energy credits for each of the plurality of users. The method further includes enabling, by a buying module, the plurality of users to buy one or more of the plurality renewable energy credits, wherein each of the plurality of renewable energy credits includes a trade certificate issued to at least one user in form of at least one of a plurality of points, megawatt of renewable energy used, and a plurality of renewable energy panels installed. The method also includes enabling, by a selling module, the plurality of users to sell the one or more of the plurality of renewable energy credits. The method further includes generating, by a trading information output module, at least one of a soft copy and a physical copy of a renewable energy credit trading information for each of the plurality of users according to one or more compliance and usage regulations set up by a governing system.

According to an aspect of the present disclosure, the plurality of users comprises at least one of a plurality of electricity suppliers, a plurality of industries, and an individual person.

According to an aspect of the present disclosure, the user can sell or buy the renewable energy credits (or the solar credits) via the online trading system. Further, the user can search one or more providers of the renewable energy/solar credits via the online trading system.

According to an aspect of the present disclosure, the users can search for a provider of renewable energy/solar credits via the online trading system.

According to an aspect of the present disclosure, the user can search one or more buyers for selling one or more renewable energy/solar credits.

According to an aspect of the present disclosure, the online trading system is a cloud-based application.

According to an aspect of the present disclosure, the online trading system is accessible via a website and a uniform resource locator (URL).

According to an aspect of the present disclosure, the users accesses the online trading system on an associated computing device for buying/selling one or more renewable energy/solar credits.

According to an aspect of the present disclosure, each of the plurality of users access the online trading system via at least one of a browsing application and a direct access application running on a computing device associated with the users.

An aspect of the present disclosure provides a platform for enabling selling and buying of at least one solar credit to/from a user for encouraging the user to use the solar energy more.

According to an aspect of the present disclosure, the online trading system is remotely located.

According to an aspect of the present disclosure, the users can save its generated/earned/un-used renewable energy/solar credits or purchased renewable energy/solar credits for future use. Therefore, in such scenarios, when the users have earned sufficient renewable energy/solar credits in a number of years then he/she can use the saved renewable energy/solar credits to pay his/her electricity bills and other bills like gas bill and so forth, by using the saved renewable energy/solar credits.

According to an aspect of the present disclosure, the online trading system enables the users to pay his/her bills such as utility bills using the saved renewable energy/solar credits in a user account of the users.

According to an aspect of the present disclosure, the online trading system may maintain details about all the renewable energy/solar credits that are earned/saved over a period of time for example, in a month, week, year, and multiple years.

According to an aspect of the present disclosure, the online trading system may act like a renewable energy/solar credit bank for the users, where the users can earn, save, or keep a track of their renewable energy/solar credits online.

According to an aspect of the present disclosure, the online trading system is part of a computing device associated with the user.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A illustrates an exemplary environment where various embodiments of the present disclosure may function;

FIG. 1B illustrates another exemplary environment where various embodiments of the present disclosure may function;

FIG. 2 illustrates another exemplary environment where various embodiments of the present disclosure may function;

FIGS. 3A-3B illustrates a flowchart of a method of buying renewable energy/solar credits as a commodity by a user through an online trading system of FIG. 1A, in accordance with an embodiment of the present disclosure;

FIGS. 4A-4B illustrates a flowchart of a method of selling renewable energy/solar credits as a commodity by a user through an online trading system of FIG. 1A, in accordance with an embodiment of the present disclosure;

FIG. 5 illustrates a flowchart of a method of retrieving renewable energy/solar credits' trading information comprising transaction details by using an online trading system, in accordance with an embodiment of the present disclosure; and

FIG. 6 is a block diagram illustrating system elements of an online trading system, in accordance with an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

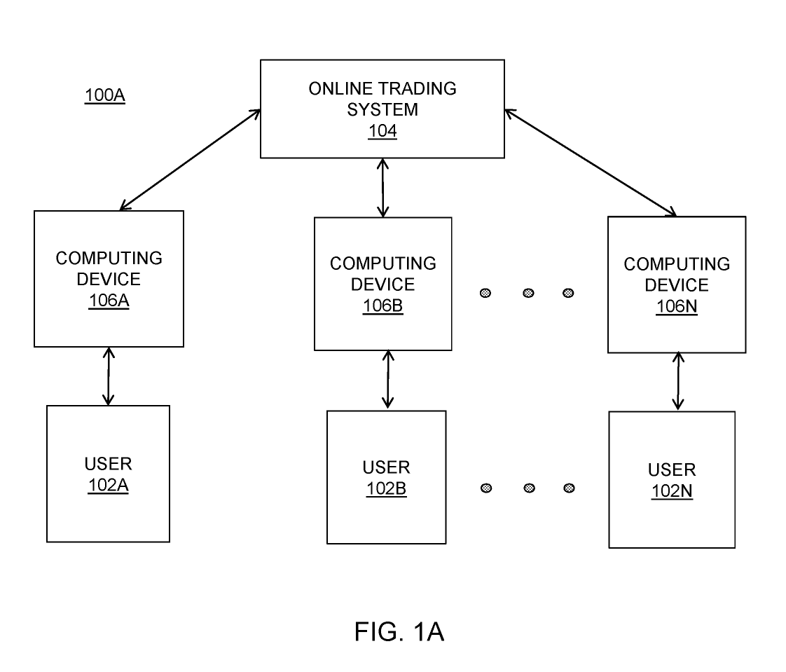

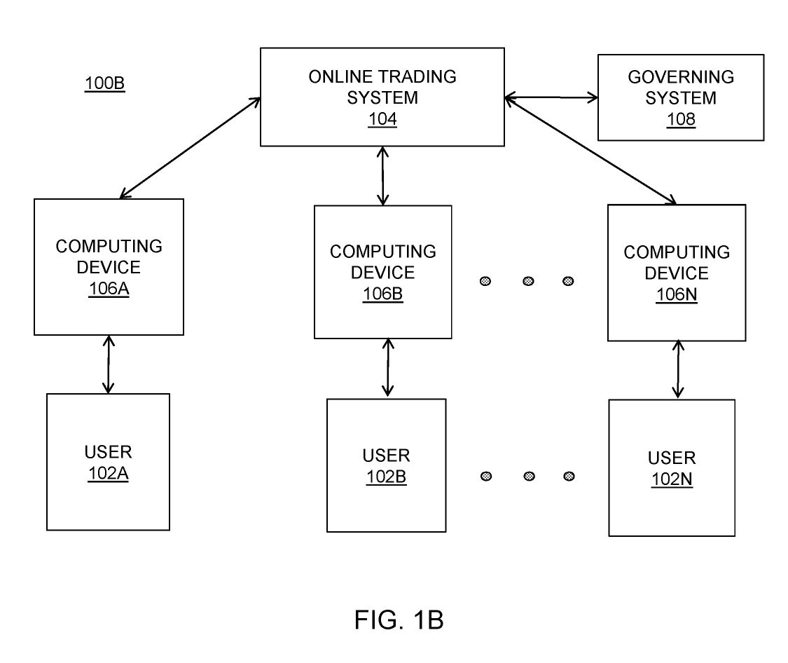

FIG. 1A illustrates an exemplary environment 100A where various embodiments of the present disclosure may function. As shown, the environment 100A primarily includes a plurality of users 102A-102N, an online trading system 104 and a number of computing devices 106A-106N associated with the users 102A-102N, respectively. The users 102A-102N may include such as, but not limited to, individual users, electricity suppliers, industries, and so forth. In some embodiments, the electricity suppliers may also be supplier of the renewable energy/solar credits. The online trading system 104 may include software, hardware, firmware or combination of these. Further, the online trading system 104 may be a single device or may include multiple devices.

The online trading system 104 provides a platform or an interface to the users 102A-102N to buy and sell renewable energy/solar credits. The renewable energy credits may include such as, but not limited to, wind energy credits, biomass energy credits, geothermal energy credits, water/hydro credits, solar credits, and so forth. The solar credits may include a certificate issued to at least one of the users 102A-102N in form of at least one of a number of points, megawatt of solar energy used, and a plurality of solar panels installed.

The users 102A-102N may re-sell or purchase the renewable energy credits (or solar credits) to and from another user(s) or from a provider of renewable energy credits (or solar credits). Each of the renewable energy credits may include at least one of a number of points earned, an amount of renewable energy consumed, and a number of panels installed for generating the renewable energy. The renewable energy credits may also be referred as green environment certificates. In some embodiments, the provider may be a supplier capable of providing renewable energy or solar energy in form of solar credits to the users 102A-102N.

In some embodiments, the users 102A-102N may earn renewable energy/solar credits either by installing one or more panels for generating renewable energy or solar energy or by saving the previously purchased renewable energy/solar credits. In such embodiments, the online trading system 104 may allow at least one of the users 102A-102N to re-sell the earned/saved renewable energy credits to another user. The renewable energy credits may include solar credits based on solar energy generation/utilization. In some embodiments, the users 102A-102N can save its generated/earned/un-used renewable energy/solar credits or purchased renewable energy/solar credits for future use. Therefore, in such scenarios, the users 102A-102N can earn sufficient renewable energy/solar credits in a number of years and then can use to pay his/her electricity bills and other bills like gas bill and so forth, by using the saved renewable energy/solar credits. The online trading system 104 may maintain details about all the renewable energy/solar credits that are earned/saved over a period of time for example, in a month, week, year, and multiple years. In some embodiments the online trading system 104 may act like a renewable energy/solar credit bank for the users 102A-102N, where the users 102A-102N can earn, save their renewable energy/solar credits online and can keep a track of the same.

Further, the online trading system 104 may be a global system and may enable the users 102A-102N spread across the world to buy and sell renewable energy credits online. In some embodiments, the users 102A-102N registers with the online trading system 104 using one or more login credentials. The login credentials are unique to each of the users 102A-102N. The login credentials allows the users 102A-102N to access the online trading system from anywhere via a network such as, but not limited to, the Internet.

In some embodiments, the users 102A-102N access the online trading system 104 via their associated computing devices 106A-106N. Further, in some embodiments, the online trading system 104 is a server remotely located from the computing devices 106A-106N of the users 102A-102N. The users 102A-102N can access the online trading system 104 via an application running on the computing devices 106A-106N. In alternative embodiments, the users 102A-102N can access the online trading system 104 via a browsing application on the computing devices 106A-106N.

In some embodiments, the users 102A-102N may be located in different countries. The users 102A-102N may buy, sell, or exchange their renewable energy credits (or solar credits) with each other through the online trading system 104 irrespective of their location. For example, if the user 102A have solar credits, but his consumption is less than the solar energy (or electricity generated from solar energy) needed, then the user 102A may sell the solar credit to another user 102C which may be located in a different or same country. The user 102A may be of a country such as, but not limited to, Ireland, and the another user 102C may be of a different country such as China. In some embodiments, the users 102A may choose to save the solar credits for future use. Therefore, the online trading system 104 allows the users 102A-102N to exchange, purchase, and sell the renewable energy credits, such as the solar credits, to other users located all over the world. In an embodiment, one solar credit may allow the users 102A-102N to utilize one megawatt of electricity generated using solar energy.

In some embodiments, the users 102A-102N may identify or search one or more suppliers or provider of renewable energy credits (solar credits) via the online trading system 104. Thereafter, the users 102A-102N may purchase the renewable energy credits from the one or more suppliers/providers as per a requirement of the users 102A-102N. The renewable energy credits or the solar credits may be sold separately from the electricity and may represent a solar aspect of the electricity produced using renewable energy like solar energy. In some embodiments, the solar credits may be purchased by the users 102A-102N such as the electricity suppliers needing to meet solar renewable portfolio standard (RPS) requirement, to industries, or to even individual users. The renewable portfolio standard is a regulation that requires the increased production of energy from renewable energy sources. Examples of the renewable energy source may include, but are not limited to, wind, geothermal, biomass, water, and solar energy (sun). The renewable energy may be used to generate power, such as electricity, that may be further be used for multiple purposes like in homes and industries.

In some embodiments, the users 102A-102N may include a number of renewable energy suppliers (not shown) configured to sell the plurality of renewable energy credits (or wind credits, hydro energy, biomass energy, and solar credits) as per demand/requirement of one or more of the users 102A-102N. The renewable energy suppliers may also register with the online trading system 104 for selling the renewable energy credits (or solar credits).

The online trading system 104 maintains information about the users 102A-102N and the renewable energy suppliers, transaction history of each of the users 102A-102N, the computing devices 106A-106N, the renewable energy/solar credits, and so forth.

FIG. 1B illustrates another exemplary environment 100B where various embodiments of the present disclosure may function. As shown the environment 100B includes the users 102A-102N, the online trading system 104, the computing devices 106A-106N, and a governing system 108. The online trading system 104 may be configured to allow the users 102A-102N to sell and purchase the renewable energy/solar credits according to one or more rules specified by the governing system 108. In some embodiments, the renewable energy credit may include a tradable certificate or permit that may be earned when a specific amount of renewable energy is used or generated by a particular user. In some embodiments, the renewable energy source is the sun and the renewable energy credits are solar credits. In some embodiments, the solar credit may include a tradable certificate or permit that may be earned when a specific amount of solar energy is used or generated by a particular user (or the users 102A-102N).

Further, the governing system 108 may determine a value of the renewable energy credits (or the solar credits). A value of the solar credits may be defined or set by the governing system 108 based on one or more compliance limits and factors including such as, but not limited to, a jurisdiction, and so forth. The governing system 108 may include a market/compliance body that is subjected to supply and demand constraints. In an embodiment, one renewable energy credit may allow the users 102A-102N to utilize one megawatt of electricity generated using renewable energy from a renewable energy source. In some embodiments, the governing system 108 defines a number of rules and limitations governing a usage of the renewable energy and buying and selling of the renewable energy credits. For example, the governing system 108 may set a minimum limit and a maximum limit for buying and selling of renewable energy credits via the online trading system 104. Further, the governing system 108 may set up rules of solar energy and solar credit usage. The users 102A-102N may follow the rules for utilizing the renewable energy and earning renewable energy credits.

In some embodiments, the governing system 108 may cap the renewable energy use and then markets may be used to allocate the renewable energy/solar credits among the group of regulated sources. In some embodiments, the governing system 108 may cap the solar energy usage. Further, in some embodiments, the renewable energy mitigation may generate renewable energy credits such as but not limited to, solar credits. Since renewable energy mitigation projects generate credits, this approach can be used to finance renewable energy usage schemes between trading partners/users and around the world. According to an aspect of the present disclosure, the market capping for monitoring the use of the solar credit may be done by at least one of designated groups, non-government organization, or designated individuals. In some embodiments, the governing system 108 does the market capping.

In some embodiments, the users 102A-102N may earn some points for following rules and for using renewable sources of energy such as, but not limited to solar energy, and may redeem these points or rewards for renewable energy credits or solar credits later via the online trading system 104. In some embodiments, the user 104 may have to pay a fine for not being compliant with the rules and renewable energy usage. The users 102A-102N can pay the fine through the online trading system 104. In some embodiments, the users 102A-102N may earn solar credits (or renewable energy credits) by using the solar energy more than a pre-defined maximum limit set by the governing system 108. In some embodiments, the users 102A-102N may use the solar energy for generating electricity from the solar energy, and then utilizing the electricity for multiple purposes, for example, for lighting at a home. In other embodiments, the users 102A-102N may be charged with a fine, which can be in terms of money, etc., when the users 102A-102N are not able to use solar energy (or renewable energy of renewable sources) according to a specified low limit set by the governing system 108. In some embodiments, the users 102A-102N may be given a discount for following the rules set by the governing system 108 via the online trading system 104.

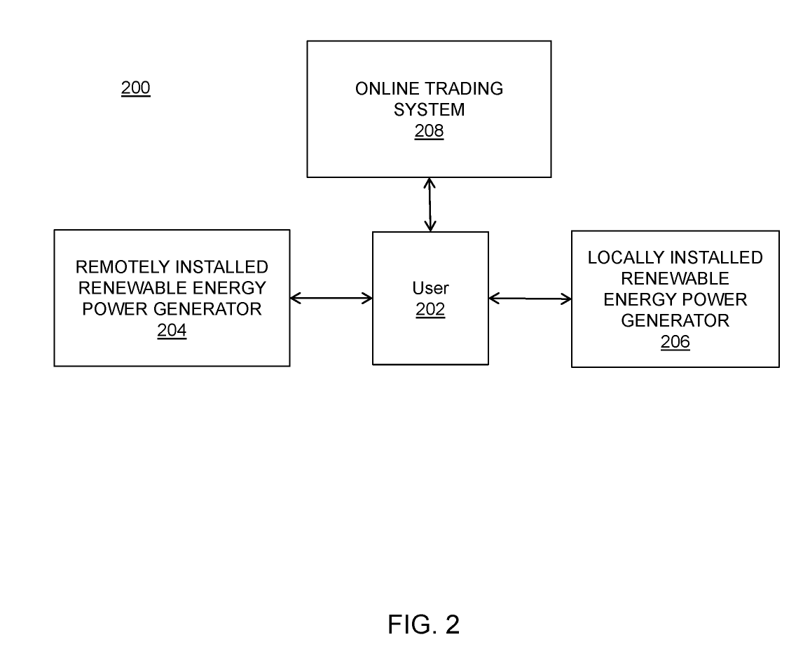

FIG. 2 illustrates another exemplary environment 200 where various embodiments of the present disclosure may function. As shown, the environment 200 includes a number of users 202, a remotely installed renewable energy power generator 204, a locally installed renewable energy power generator 206, and an online trading system 208. In an example, the users 202 may be an individual user. The online trading system 208 is similar in function and structure to the online trading system 104 of FIGS. 1A-1B.

In some embodiments, each of the users 202 can earn or enjoy renewable energy/solar credits (hereinafter also referred in as green environment certificates) by locally or remotely installing one or more renewable energy panels for generating renewable energy or solar energy for normal and compliance use of the renewable/solar energy. In some embodiments, the renewable energy may include the solar energy generated from the solar energy resource i.e. the Sun. The panels may be solar panels for generating electricity using the solar energy. In some other embodiments, the users 202 may earn renewable energy credits by following the rules governing the renewable energy usage. The rules may be set by the governing system 108. The renewable energy credits may be solar credits. In some embodiments, the solar credit may include a tradable certificate or permit that may be earned when a specific amount of solar energy is used or generated by a particular user.

The remotely installed renewable energy power generator 204 may include a number of panels located remote from the users 202 for generating electricity. In some embodiments, the remotely installed renewable energy power generator 204 comprises an electricity provider. In some embodiments, the users 202 may own the remotely installed renewable energy power generator 204. In other embodiments, the remotely installed renewable energy power generator 204 may not belong to the users 202. The users 202 may only buy the renewable energy credits from the remotely installed renewable energy power generator 204 for utilizing the renewable energy via the online trading system 208.

The locally installed renewable energy power generator 206 may include a number of panels for generating electricity. The panels may be solar panels for generating electricity using solar energy/sun. The users 202 may install the locally installed renewable energy power generator 206 locally.

The users 202 may earn renewable energy credits including such as, but not limited to, solar credits for solar energy generated using the remotely installed renewable energy power generator 204 and the locally installed renewable energy power generator 206. The users 202 may utilize all or some of the renewable energy credits (or solar credits). In some embodiments, the users 202 may sell or exchange some or all of the renewable energy credits (or solar credits) with other users that may or may not be in different countries via the online trading system 208.

In some embodiments, the users 202 can save its generated/earned/un-used renewable energy/solar credits or purchased renewable energy/solar credits for future use. Therefore, in such scenarios, when the users 202 have earned sufficient renewable energy/solar credits in a number of years then he/she can use the saved renewable energy/solar credits to pay his/her electricity bills and other bills like gas bill and so forth, by using the saved renewable energy/solar credits. The online trading system 208 enables the users 202 to pay his/her bills such as utility bills using the saved renewable energy/solar credits in a user account of the users 202. The online trading system 208 may maintain details about all the renewable energy/solar credits that are earned/saved over a period of time for example, in a month, week, year, and multiple years. In some embodiments the online trading system 208 may act like a renewable energy/solar credit bank for the users 202, where the users 202 can earn, save, or keep a track of their renewable energy/solar credits online.

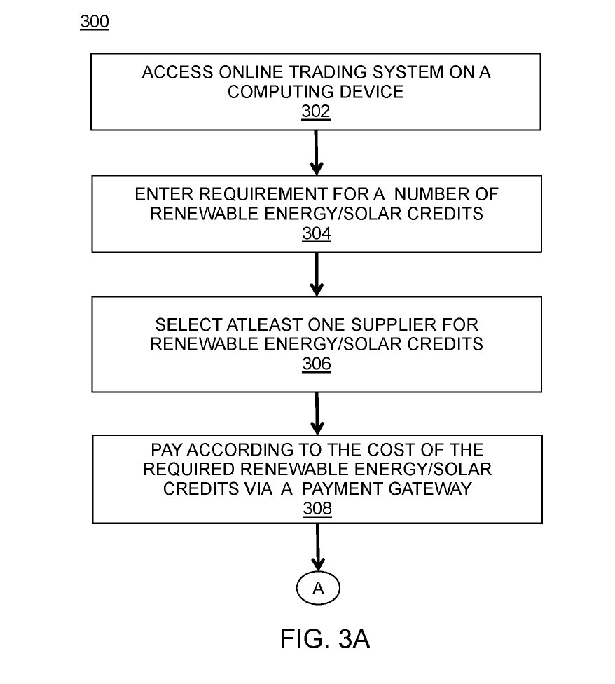

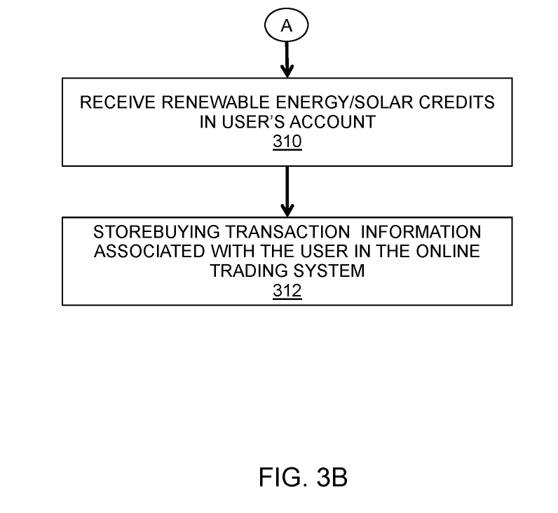

FIGS. 3A-3B illustrates a flowchart of a method 300 of buying renewable energy/solar credits as a commodity by using an online trading system (such as the online trading system 104 of FIG. 1A), in accordance with an embodiment of the present disclosure. At step 302, a user (See 102A-102N of FIG. 1A) can access the online trading system (104). In some embodiments, the user accesses the online trading system by registering with the online trading system and/or entering one or more login credentials via an associated computing device.

At step 304, the user enters a requirement for a number of renewable energy/solar credits he/she needs to buy. The online trading system may display a list of suppliers of the renewable energy/solar credits to the user. Then at step 306, the user selects at least one supplier of the renewable/solar credits from the displayed list of the suppliers. Then at step 308, the user pays according to a cost of the required renewable energy/solar credits via a payment gateway. In some embodiments, the payment gateway may be provided by the online trading system.

Then at step 310, the user receives the renewable energy/solar credits in an associated user account with the online trading system. Thereafter, transaction information of the buying or purchase transaction is stored in a database of the online trading system for future use. Thereafter, at step 312, the buying transaction information associated with the user is stored in the online trading system.

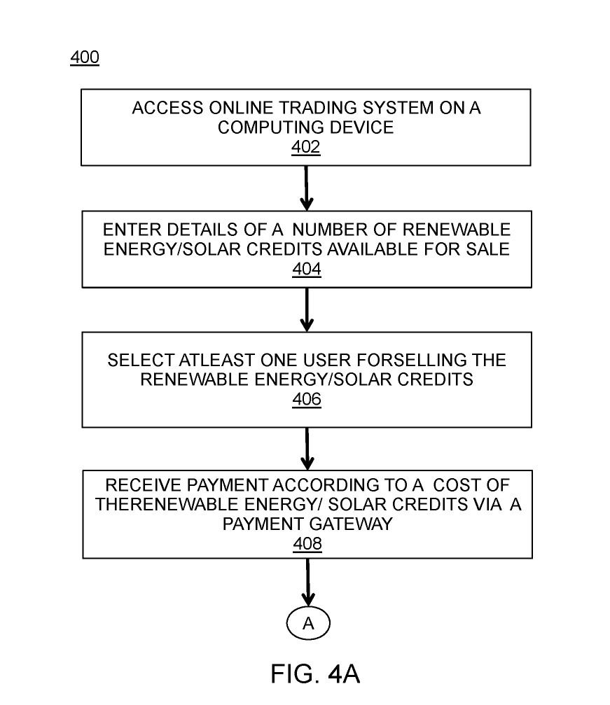

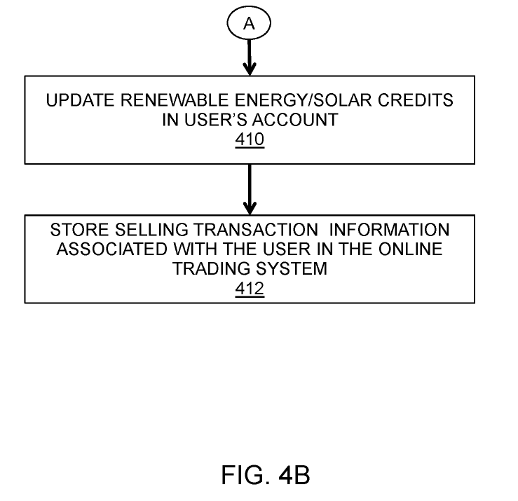

FIGS. 4A-4B illustrates a flowchart of a method 400 of selling renewable energy/solar credits as a commodity by using an online trading system (such as the online trading system 104 of FIG. 1A), in accordance with an embodiment of the present disclosure. At step 402, a user (See 102A-102N of FIG. 1A) can access the online trading system via an associated computing device. The computing device can be a phone, a smart phone, a computer, a laptop computer, a tablet computer, and so forth. In some embodiments, the user accesses the online trading system by registering with the online trading system and/or entering one or more login credentials.

At step 404, the user enters details about a number of renewable energy/solar credits available for sale. The online trading system displays a list of users or buyers. Then at step 406, the user selects at least one user or buyer from the list of users/buyers for selling the renewable energy/solar credits through the online trading system (See 104 of FIG. 1A). Then at step 408, the user receives a payment according to a cost of the renewable energy/solar credits via a payment gateway. In some embodiments, the payment gateway may be provided by the online trading system.

Then at step 410, the number of renewable energy/solar credits is updated in a user account associated with the user in the online trading system. Thereafter, at step 412, the selling transaction information is stored in a database of the online trading system for future use. In some embodiments, the user may exchange the renewable energy/solar credits for some other thing than cash or money for example, points or some other product, with other users/buyers via the online trading system.

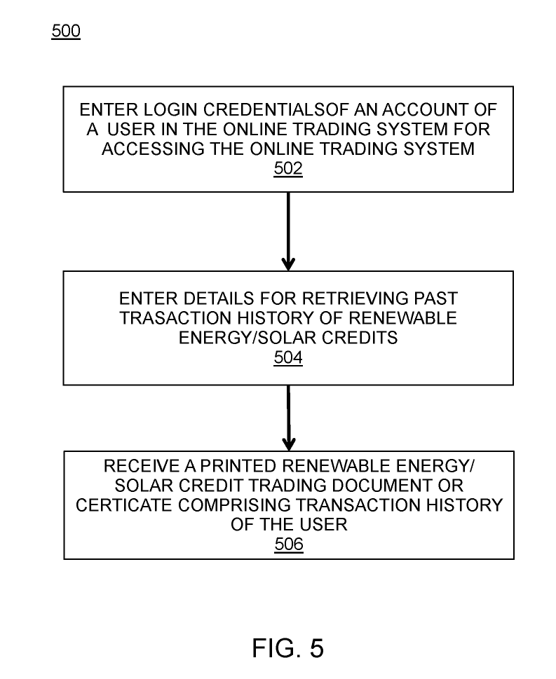

FIG. 5 illustrates a flowchart of a method 500 of retrieving renewable energy/solar credits' trading information comprising transaction details by using an online trading system, in accordance with an embodiment of the present disclosure. At step 502, a user enters his/her login credentials for accessing the online trading system (e.g. 104) on an associated computing device for example, a smart phone. At step 504, the user enters details for retrieving past transaction history of renewable energy/solar credits on the online trading system. These transactions were done in past using the online trading system. The transaction may include buying/selling transactions. Thereafter, the online trading system prints or retrieves the transaction history in form of a trading document. At step 506, the user receives a printed renewable energy/solar credit trading document or certificate including the past transaction history of the user for buying/selling transactions.

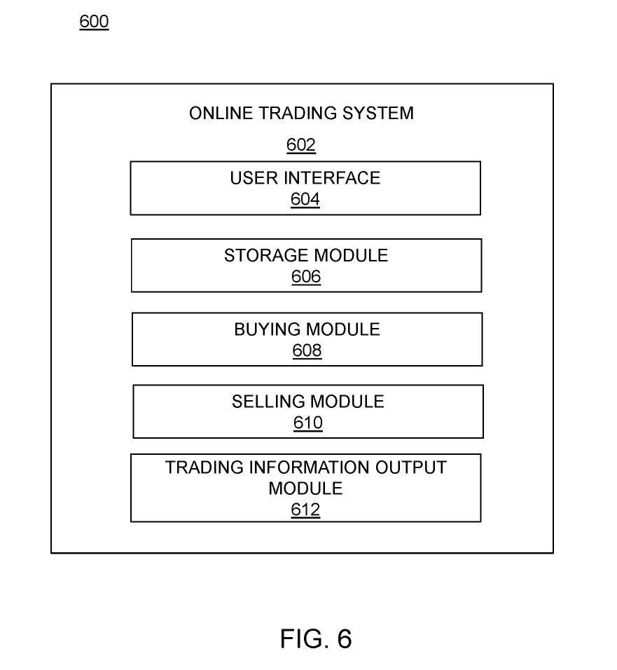

FIG. 6 is a block diagram 600 illustrating system elements of an online trading system 602, in accordance with an embodiment of the present disclosure. As shown, the online trading system 602 primarily includes a user interface 604, a storage module 606, a buying module 608, a selling module 610, and a trading information output module 612. As discussed with reference to FIG. 1A, the users 102A-102N can access the one or more modules of the online trading system 602 via the user interface 604. The user interface 604 may include one or more graphical objects, text fields, one or more options, and so forth.

The storage module 606 is configured to store information about the plurality of users 102A-102N, the plurality of computing devices 106A-106N associated with the users 102A-102N, a plurality of suppliers (not shown) of the solar credits, and a plurality of renewable energy/solar credits. Each of the plurality of renewable energy/solar credits may include a trade certificate issued to at least one of the users 102A-102N in form of at least one of a plurality of points, megawatt of renewable/solar energy used, and a plurality of renewable energy/solar panels installed. In some embodiments, the storage module 606 may store information about the login credentials of the users 102A-102N, and the computing devices 106A-106N.

The users 102A-102N can buy one or more renewable energy/solar credits via the online trading system 602. The buying module 608 is configured to process one or more buying transactions for enabling the users 102A-102N to buy one or more renewable energy/solar credits.

The users 102A-102N can sell one or more renewable energy/solar credits via the online trading system 602. The selling module 610 is configured to enable the users 102A-102N to sell the one or more renewable energy/solar credits.

Further, the users 102A-102N can retrieve or view past history of transactions done by accessing the online trading system 602 on their associated computing devices 106A-106N. The users 102A-102N can enter details about one or more transactions to retrieve past history. The trading information output module 612 is configured to generate at least one of a soft copy and a physical copy of a renewable energy/solar credit trading information or transactions for each of the users 102A-102N. The renewable energy/solar credit trading information may be presented on a screen of the computing devices 106A-106N. In some embodiments, the renewable energy/solar credit trading information is printed and provided to the users 102A-102N as a document.

The present disclosure provides methods and systems for buying and selling of renewable energy/solar credits as a commodity.

An embodiment of the present disclosure provides a method for using solar energy as a commodity in form of a solar credit, and encouraging the people to use the solar energy by buying the solar credits online using the online trading system 104.

According to an aspect of the present disclosure, the users 102A-102N may be charged with a fine, which can be in terms of money, etc., via the online trading system 104 when the user is not able to use solar energy (or renewable energy of renewable sources) according to a specified low limit set by the governing system 108. The user can pay the fine by using the online trading system from anywhere, irrespective of their location. Further, the user (or users 102A-102N) can access the online trading system 104 from his/her computing device such as the computing devices 106A-106N.

The present disclosure enables the users 202 (or 102A-102N) to save its generated/earned/un-used renewable energy/solar credits or purchased renewable energy/solar credits for future use. Therefore, in such scenarios, when the users 202 have earned sufficient renewable energy/solar credits in a number of years then he/she can use the saved renewable energy/solar credits to pay his/her electricity bills and other bills like gas bill and so forth, by using the saved renewable energy/solar credits. The disclosed online trading system 208 (or 104) enables the users 202 to pay his/her bills such as utility bills using the saved renewable energy/solar credits present in a user account of the users 202. The online trading system 208 may maintain details about all the renewable energy/solar credits that are earned/saved over a period of time for example, in a month, week, year, and multiple years. In some embodiments the online trading system 208 (or 104) may act like a renewable energy/solar credit bank for the users 202, where the users 202 can earn, save, their renewable energy/solar credits online and can keep a track of the same.

In some embodiments, the users 102A-102N can check their renewable energy/solar credits balance available via the online trading system 104.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. An online trading system for managing a sale and purchase of a plurality of solar credits as a commodity, the online trading system comprising:
a user interface configured to enable a plurality of users to interact with the system;
a storage module configured to store information about the plurality of users, a plurality of computing devices associated with the users, a plurality of suppliers of the solar credits, the plurality of solar credits, the information comprising one or more credentials of the plurality of users, a plurality of computing devices, and past history of solar credits for each of the plurality of users;
a buying module configured to enable the plurality of users to buy one or more of the plurality solar credits, wherein each of the plurality of solar credits comprises a trade certificate issued to at least one user in form of at least one of a plurality of points, megawatt of solar energy used, and a plurality of solar panels installed;
a selling module configured to enable the plurality of users to sell the one or more of the plurality of solar credits; and
a trading information output module configured to generate at least one of a soft copy and a physical copy of a solar credit trading information for each of the plurality of users according to one or more compliance and usage regulations set up by a governing system.

2. The online trading system of claim 1, wherein the plurality of users comprises at least one of a plurality of electricity suppliers, a plurality of industries, and an individual person.

3. A method for managing a sale and purchase of a plurality of solar credits as a commodity, the method comprising:
enabling a plurality of users to interact with the system via a user interface;
maintaining, by a storage module, information about the plurality of users, a plurality of computing devices associated with the users, a plurality of suppliers of the solar credits, the plurality of solar credits, the information comprising one or more credentials of the plurality of users, a plurality of computing devices, and past history of solar credits for each of the plurality of users;
enabling, by a buying module, the plurality of users to buy one or more of the plurality solar credits, wherein each of the plurality of solar credits comprises a trade certificate issued to at least one user in form of at least one of a plurality of points, megawatt of solar energy used, and a plurality of solar panels installed;
enabling, by a selling module, the plurality of users to sell the one or more of the plurality of solar credits; and
generating, by a trading information output module, at least one of a soft copy and a physical copy of a solar credit trading information for each of the plurality of users according to one or more compliance and usage regulations set up by a governing system.

4. The method of claim 3, wherein the users comprises at least one of a plurality of electricity suppliers, a plurality of industries, and an individual person.

5. A system for transacting renewable energy credits online, the system comprising:
an online trading system comprising:
a storage module configured to store information about a plurality of users, a plurality of computing devices associated with the users, a plurality of suppliers of the renewable energy credits, and a plurality of renewable energy credits, wherein each of the plurality of renewable energy credits comprises a trade certificate issued to at least one user in form of at least one of a plurality of points, megawatt of renewable energy used, and a plurality of panels installed;
a buying module configured to enable the plurality of users to buy one or more of the plurality renewable energy credits;
a selling module configured to enable the plurality of users to sell the one or more of the plurality of renewable energy credits; and
a trading information output module configured to generate at least one of a soft copy and a physical copy of a renewable energy credit trading information for each of the plurality of users; and
a computing device comprising a user interface configured to enable the plurality of users to interact with the online trading system; and

[symbol]

6. The system of claim 5, wherein the plurality of users comprises at least one of a plurality of electricity suppliers, a plurality of industries, and an individual person.

7. The system of claim 5, wherein each of the plurality of users access the online trading system via at least one of a browsing application and a direct access application running on a computing device associated with the plurality of users.

8. The system of claim 5, wherein the system comprising:
an online trading system comprising:
a storage module configured to store information about a plurality of users, a plurality of computing devices associated with the users, a plurality of suppliers of the solar credits, and a plurality of solar credits, wherein each of the plurality of solar credits comprises a trade certificate issued to at least one user in form of at least one of a plurality of points, megawatt of solar energy used, and a plurality of solar panels installed;
a buying module configured to enable the plurality of users to buy one or more of the plurality solar credits;
a selling module configured to enable the plurality of users to sell the one or more of the plurality of solar credits; and
a trading information output module configured to generate at least one of a soft copy and a physical copy of a solar credit trading information for each of the plurality of users; and
a computing device comprising a user interface configured to enable the plurality of users to interact with the online trading system.

9. The system of claim 8, wherein the plurality of users comprises at least one of a plurality of electricity suppliers, a plurality of industries, and an individual person.

10. The system of claim 8, wherein each of the plurality of users access the online trading system via at least one of a browsing application and a direct access application running on a computing device associated with the plurality of users.

11. The method of claim 3, wherein the method comprising:
enabling a plurality of users to interact with the system via a user interface;
maintaining, by a storage module, information about the plurality of users, a plurality of computing devices associated with the users, a plurality of suppliers of the renewable energy credits, the plurality of renewable energy credits, the information comprising one or more credentials of the plurality of users, and past history of renewable energy credits for each of the plurality of users;
enabling, by a buying module, the plurality of users to buy one or more of the plurality renewable energy credits, wherein each of the plurality of renewable energy credits comprises a trade certificate issued to at least one user in form of at least one of a plurality of points, megawatt of renewable energy used, and a plurality of renewable energy panels installed;
enabling, by a selling module, the plurality of users to sell the one or more of the plurality of renewable energy credits; and
generating, by a trading information output module, at least one of a soft copy and a physical copy of a renewable energy credit trading information for each of the plurality of users according to one or more compliance and usage regulations set up by a governing system.
